(19) United States
(12) Patent Application Publication
(10) Pub. No.: US 2024/0149330 A1
(43) Pub. Date: May 9, 2024

(54) Joining Device and Method for Operating a Joining Device

(71) Applicant: Bayerische Motoren Werke Aktiengesellschaft, Muenchen (DE)

(72) Inventors: Johannes SCHARRER, Bogen (DE); Manuel WALLA, Aham (DE)

(21) Appl. No.: 18/549,285

(22) PCT Filed: Jan. 19, 2022
(86) PCT No.: PCT/EP2022/051069

§ 371 Date: Sep. 6, 2023

(30) Foreign Application Priority Data
Mar. 8, 2021 (DE) 10 2021 105 466.4

(51) Int. Cl. B21J 15/32; B23K 9/20; B23P 19/00

(52) U.S. Cl. CPC B21J 15/32; B23K 9/206; B23P 19/005

(57) ABSTRACT

A joining device includes a mobile joining head with a joining tool which is arranged on an industrial robot, an element feed system, and a control device which is configured to activate the joining tool and control the element feed system. The element feed system has a magazine device which is movable with the joining head and which has a working magazine in which a large number of joining elements are accommodatable at a same time and a separating device from which joining elements are conveyable onward from the magazine device in a direction of the joining tool, a stand-by magazine which is stationary and which is fillable with joining elements from a sorting device, and a coupling device that couples the magazine device to the stand-by magazine where a first coupling half is arranged on the magazine device and a second coupling half is arranged on the stand-by magazine.

### BACKGROUND AND SUMMARY OF THE INVENTION

The invention relates to a joining device for joining elements and to a method for operating a joining device.

In the automobile industry, for example automobile body construction, a large number of small joining elements are processed, for example welding joining elements or riveting elements. In automated processes, the joining tools are usually assembled on an industrial robot which performs the positioning of the joining tool at the respective joining location. An industrial robot with a stud welding head, for example, thus moves to predefined positions on a vehicle body one after the other, and the joining tool welds a welding stud to the body at each of these positions.

An element feed system is used in order to supply the joining elements at the joining head. The joining elements are supplied, for example, in bulk, are separated out and oriented in a sorting device, and transported onward by the element feed system individually by means of compressed air through a compressed-air feed duct, which can be designed for example as a feed hose, to the joining tool where they are processed. The sorting device is usually positioned outside the working range of the industrial robot such that the joining elements have to be transported over a long distance of several meters to the joining tool. If the joining locations to which the robot needs to move are situated close together, the situation can arise where a new joining element has not yet arrived in the joining tool and the robot has to wait. This increases the duration of the process and the downtime of the joining installation.

The not prepublished German application 10 2021 104 140.6 discloses a joining device with a pre-separating device which is arranged on the joining head. The joining elements are transported individually from the sorting device to the pre-separating device and temporarily stored there in a kind of stand-by position. If a new joining element is required by the joining head, it is fed from the pre-separating device and the latter is refilled again. By virtue of the pre-separating device, it is possible to quickly re-equip the joining head with a joining element between two joining processes.

Against this background, the object of the present invention is to provide the possibility of being able to further improve an automated joining process for joining elements.

A joining device is provided with a mobile joining head, with a joining tool, which is arranged on a multi-axis industrial robot. The multi-axis robot holds and guides the joining head with the joining tool and enables it to be repositioned between two joining processes. The joining device furthermore has an element feed system which operates using compressed air, and a control device which is configured to actuate the joining tool and to control the element feed system.

By virtue of the element feed system, joining elements can be transported by means of compressed air to the mobile joining head from a sorting device in which they are separated and oriented in the correct position. The element feed system contains a magazine device which can be moved together with the joining head. For this purpose, the magazine device can be assembled, for example, on the joining head or on a common holder which is moved by the robot. The magazine device has a working magazine and a separating device. The working magazine is configured such that a large number of joining elements can be accommodated at the same time. The separating device is configured to convey the joining elements contained in the working magazine onward individually in the direction of the joining head. At the joining head, the joining element preferably passes into an element holder which holds the joining element in a defined position at the beginning of the joining process. For this purpose, a compressed-air duct can preferably extend from the separating device as far as the element holder.

The element feed system furthermore contains a stand-by magazine which is arranged so that it is stationary and which can be filled with joining elements from the sorting device. In order to fill the stand-by magazine, the joining elements are conveyed from the sorting device into the stand-by magazine by means of compressed air. The stand-by magazine is designed to accommodate a large number of joining elements.

The element feed system furthermore has a coupling device for coupling the magazine device to the stand-by magazine, wherein a first coupling half is arranged on the magazine device and a second coupling half is arranged on the stand-by magazine. Coupling is effected by the first coupling half being brought into engagement with the second coupling half. As a result, the stand-by magazine is connected to the working magazine and the joining elements can be transported onward from the stand-by magazine into the working magazine. The element feed system can, for example, furthermore contain a compressed air supply or be connected to such a supply.

In other words, the element feed system is in two parts: the magazine device with the working magazine can be moved with the joining head and supplies sufficient joining elements for a number of joining operations. The stand-by magazine is stationary and can be refilled whilst work is ongoing with the working magazine. By virtue of this configuration, there is no longer any need for a feed hose by which joining elements can be transported from the sorting device to the joining head. Such feed hoses are prone to wear because they have to follow the movements of the robot. The proposed element feed system has almost no wear and is low-maintenance. Because the joining elements are stored in the working magazine, they reach the joining head quickly, which allows the time between two joining operations to be reduced. The process does not need to be interrupted in order to dock the working magazine with the stand-by magazine and to transfer the joining elements and instead this can take place in idle times, for example when there is a change of workpiece.

In a preferred embodiment, the control device is furthermore configured to generate a first signal which, on the one hand, causes a joining element to be transported from the working magazine in the direction of the joining tool and, on the other hand, causes a joining element to be transported from the sorting device into the stand-by magazine. By coupling the removal from the working magazine and the filling of the stand-by magazine in this way, it is ensured in a particularly simple fashion that the stand-by magazine is filled with precisely the same number of joining elements as were removed from the working magazine. In the case of subsequent coupling of the magazines with transfer of the joining elements, the working magazine is thus filled again with exactly the same number of joining elements.

A particularly short travel path for refilling the working magazine results in an embodiment in which the stand-by magazine is attached to a console of the industrial robot. The stand-by magazine is thus situated inside the protective housing and the robot can move to it quickly and without risk. The stand-by magazine can, however, also be free-standing or fastened to a separate stand and thus positioned individually.

In one embodiment, the stand-by magazine is formed by a feed hose or a compressed-air tube. By virtue of the stationary arrangement, the wear in the hose or in the tube is reduced. The magazine can thus be formed particularly simply and be formed, for example, by a conventional element conveying hose or alternatively as a tube.

The coupling device preferably serves for the temporary coupling of the magazine device to the stand-by magazine and is designed accordingly. In order to transfer the contents of the stand-by magazine into the working magazine, the robot moves to the stand-by magazine with the magazine device such that the first and the second coupling half come into engagement with each other. The first and the second coupling half are therefore preferably designed such that they can be brought into engagement with each other by a relative movement toward each other and can be disconnected again by a relative movement away from each other. The first coupling half is arranged on the magazine device, preferably on that side of the working magazine which is situated opposite the separating device. The second coupling half is arranged on the stand-by magazine, preferably on a side of the stand-by magazine which is situated opposite the sorting device. The two magazines can thus be coupled to each other and the joining elements can be transferred by a purely linear movement. It is particularly preferred if, in one embodiment, one coupling half has a funnel-shaped socket and the second coupling half has a corresponding conical coupling piece. The conical coupling piece is then inserted into the funnel-shaped socket for coupling. This embodiment is self-centering and thus facilitates movement to it by a robot and allows higher travel speeds.

A particularly compact structure is obtained in one embodiment by the first coupling half being arranged at the same height as the last axis of the robot. The last axis refers here to the axis adjacent to the end effector.

The separating device is designed in a preferred embodiment as a pneumatically actuatable separating device. In this embodiment, the separating device preferably has a duct with a feed opening and an outlet opening through which the joining elements can be conveyed. The joining elements are introduced into the separating device through the feed opening during operation and leave the separating device, after having passed through the duct, at the outlet opening. The working magazine preferably adjoins the feed opening of the separating device. A first duct blocking element with a first actuating device and a second duct blocking element with a second actuating device are preferably provided which in each case can move between a blocking position and an pass-through position. The second duct blocking element is arranged in this embodiment behind the first duct blocking element in the conveying direction of the joining elements. The duct blocking elements are preferably spaced so far apart from each other that a duct section situated in between cannot accommodate more than one joining element. The duct blocking elements can each move between a blocking position and an pass-through position. In the blocking position, the duct blocking element prevents a joining element from being able to move past the blocking element and through the duct. In the pass-through position, the duct blocking element frees the duct and a joining element can pass through. The movement of the duct blocking elements takes place in each case by means of the associated actuating devices. The duct blocking elements can be designed, for example, preferably as slides which can be displaced transversely to the duct between the blocking position and the pass-through position.

Also preferably provided in the pneumatically actuatable separating device are a first compressed-air feed opening which opens into the duct in front of the first duct blocking element in the conveying direction, and a second compressed-air feed opening which opens into the duct between the first duct blocking element and the second duct blocking element in the conveying direction. The first and second compressed-air feed opening is preferably configured to be connected to a compressed-air supply.

By virtue of the above described structure, the pneumatically actuatable separating device provides two duct sections in which joining elements or one joining element can be stopped and then conveyed onward by a blast of compressed air in a targeted fashion. The working magazine with a large number of joining elements is situated in front of the first duct blocking element. One of these joining elements is conveyed by a blast of compressed air to a position in front of the second duct blocking element where it waits in a kind of “stand-by position” for onward transport to the joining head. This joining element is then transported to the joining head by a further blast of compressed air and a following joining element is separated from the working magazine. This embodiment of a pre-separating system requires a purely linear movement of the joining elements and therefore has a particularly simple structure and is not prone to faults.

For particularly simple activation of the separating device, in one embodiment the latter has a first compressed-air line via which compressed air can be applied to the first actuating device, the second actuating device, and the second compressed-air feed opening jointly, wherein the first actuating device is configured to move the first duct blocking element into the blocking position, and the second actuating device is configured to move the second duct blocking element into the pass-through position when compressed air is applied to the first compressed-air line. In this embodiment, the signal from the control device is used to apply compressed air to the first compressed-air line. A joining element situated in front of the second duct blocking element is consequently transported in the direction of the joining head whilst the other joining elements are retained in the working magazine.

In order to enable two different joining elements to be processed with no process interruption, in a further embodiment it is provided that the joining device has two element feed systems which are arranged parallel to each other and are routed together to the element holder of the joining head via a feed duct with a Y-piece. Each element feed system is designed as described above. If a joining element is moved by the respective element feed system in the direction of the joining head, the joining element passes via the Y-piece into the feed duct leading to the joining head. In this embodiment, the control device is preferably configured to activate the two element feed systems separately depending on which joining element is required next.

Small welding elements such as, for example, balls, double balls, nuts, welding studs with and without a thread can be used as joining elements, which can also be small joining elements for other joining methods, for example rivet or screw elements.

The joining head is in particular configured to join the joining elements which are fed from the separating device, for example, to further components in a joining process. The joining head with a joining tool can be, for example, a welding head for welding on the joining elements, in particular a drawn arc welding head. Accordingly, the joining device is designed in a preferred embodiment as a welding device or drawn arc welding device. The joining head can also have a riveting head for setting rivets or a screwing tool for screwing in the joining elements. It is also conceivable that the joining head has other joining tools such as, for example, a clinching tool.

A method for operating a joining device as described above is furthermore provided in which a large number of joining elements are joined one after the other to a component or an assembly in a joining process sequence. The joining process sequence can be, for example, the welding of welding studs onto a vehicle body, preferably onto a floor assembly. The joining elements required for the joining process sequence are supplied in the magazine device and are transported individually to the joining tool. In the example of the floor assembly, at least the number of welding studs which are to be set, typically 30 to 40 welding studs, are contained in the working magazine. A small number of spare studs can also be contained.

During the joining process sequence, the stand-by magazine is filled with joining elements by the joining elements being transported individually and in the correct position from the sorting device into the stand-by magazine. After completion of the joining process sequence, the industrial robot is moved in such a way that the working magazine is coupled to the stand-by magazine and the joining elements are transported from the stand-by magazine into the working magazine by means of compressed air.

Using the method, it is possible to supply joining elements for the whole joining process sequence in close proximity to the joining head. The working magazine can be refilled quickly and simply because the stand-by magazine is already filled up during the joining process sequence. The transfer from the stand-by magazine into the working magazine can thus take place in idle times, for example whilst the floor assembly is being replaced.

In a preferred embodiment, the element feed system is controlled such that, each time a joining element is transported from the separating device to the joining tool, a joining element is also transported from the sorting device into the stand-by magazine. Such control ensures that the same number of joining elements are always situated in the stand-by magazine as were removed from the working magazine. A first signal which is supplied by the control device is preferably used for such control. The first signal is preferably an electrical signal.

It can furthermore be provided that this first signal is in addition also used to control the joining head. The first signal is preferably also used to shift the joining head into a loading state, or the first signal indicates that the joining head is situated in a loading state. “Loading state” is understood here to mean that the joining head is ready to receive a joining element. If the joining head is, for example, a stud welding head with a loading pin, this welding head is situated in the loading state when the loading pin is drawn back. A corresponding first signal then specifies that the loading pin is drawn back, or the loading pin is drawn back inside the welding head because of this signal. Stud welding heads with a different construction are designed, for example, with rotary segments or paddle-type holders which can be moved into different positions. In this case, a first signal would analogously be used which either indicates that the rotary segment or the paddle-type holder is situated in a position in which a joining element can be loaded or which causes the rotary segment or the paddle-type holder to be moved into the corresponding position. The feeding of the joining element from the pre-separating device into the joining head is thus coupled to control of the joining device. In other words, the separating can, as well as compressed-air activation, also be controlled via the electrical signal, according to which the joining head is situated in a loading state or is shifted into a loading state (“retract loading pin” or “loading pin in retracted position”).

The control device can furthermore be configured to generate a second signal which causes compressed air to be applied to the second compressed-air line and the joining head to move forward a fed joining element, for example by pushing forward the loading pin or moving the rotary segment or paddle-type holder. As a result, pushing a joining element further in the pre-separating device from the first into the second “stand-by position” is coupled to the “loading procedure” inside the joining head. This embodiment achieves particular advantages because no separate control signals are required in order to operate the pre-separating device. Instead, the complete feeding of the joining elements can be controlled with the aid of the same signals which are required to activate the joining head. A particularly simple implementation of this activation results if the first compressed-air line is coupled to a compressed-air line which is used in the joining device in order to produce the loading state (for example, drawing back the loading pin). Likewise, the second compressed-air line can be coupled to a further compressed-air line which is used to move forward the joining element in the joining head (for example, pushing forward the loading pin). The supplying of compressed air for separating the joining elements can be effected externally via an additional air hose or internally via the air supply from the welding head.

Features and details which are described in connection with the joining device apply also in connection with the method according to the invention and vice versa such that reference is or can be made always reciprocally to the individual aspects of the invention in terms of the disclosure.

Further advantages, features, and details of the invention can be found in the following description in which exemplary embodiments of the invention are described in detail with reference to the drawings. The features mentioned in the claims and in the description can here be essential to the invention in each case individually per se or in any desired combination. Where the word “can” is used in this application, it refers both to the technical possibility and the actual technical implementation.

Exemplary embodiments are explained below with the aid of the attached drawings.

### BRIEF DESCRIPTION OF THE DRAWINGS

FIG. 1 shows an example of a joining device;

FIGS. 2 to 4 show the element feed system of the joining device from FIG. 1 in order to illustrate the method sequence; and

FIG. 5 shows a further example of an element feed system.

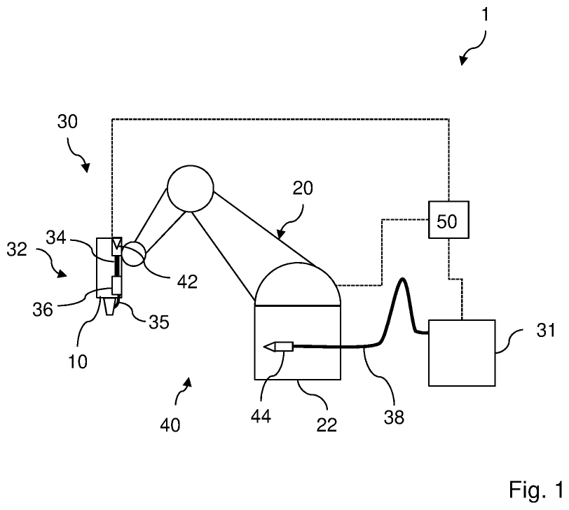

### DETAILED DESCRIPTION OF THE DRAWINGS

An example of a joining device 1 has a mobile joining head 10, with a joining tool, which is fastened to a multi-axis industrial robot 20 and can be positioned by means of the latter. For the joining process, the joining head 10 is moved to the respective joining locations and a joining element 2 is joined there to a component (not illustrated) by means of the joining tool.

In order to feed the joining elements 2 to the joining tool, the joining device 1 furthermore has an element feed system 30 by means of which the joining elements 2 are separated by a sorting device 31 and can be conveyed to a discharge opening at the joining head 10 in the correct position by means of compressed air. The sorting device 31 is here usually arranged spaced apart from the industrial robot 20, outside a protective housing (not illustrated) and is preferably arranged so that it is stationary. The element feed system 30 contains a magazine device 32 which is fastened to the joining head 10 and can be moved together with the joining head 10. The magazine device 32 has a working magazine 34 and a separating device 36. A large number of joining elements can be accommodated at the same time in the working magazine 34. The separating device 36 is configured to convey onward the joining elements contained in the working magazine 34 individually in the direction of the joining head 10. At the joining head, the joining element passes into an element holder which holds the joining element in a defined position at the beginning of the joining process. For this purpose, a feed duct 35 extends from the separating device 36 to the element holder.

The element feed system 30 furthermore contains a stand-by magazine 38 which is arranged so that it is stationary on the robot console 22 and can be filled with joining elements from the sorting device 31. In order to fill the stand-by magazine 38, the joining elements are conveyed by means of compressed air from the sorting device 31 into the stand-by magazine 38. The stand-by magazine 38 is designed to accommodate a large number of joining elements.

The element feed system 30 furthermore has a coupling device 40 for coupling the magazine device to the working magazine, wherein a first coupling half 42 is arranged on the magazine device 32 and a second coupling half 44 is arranged on the stand-by magazine 38. The element feed system 30 furthermore contains a compressed-air supply (not illustrated).

The joining device 1 furthermore has a control device 50 which is configured to activate the element feed system 30 and the industrial robot 20 and to activate the joining head 10 with the joining tool.

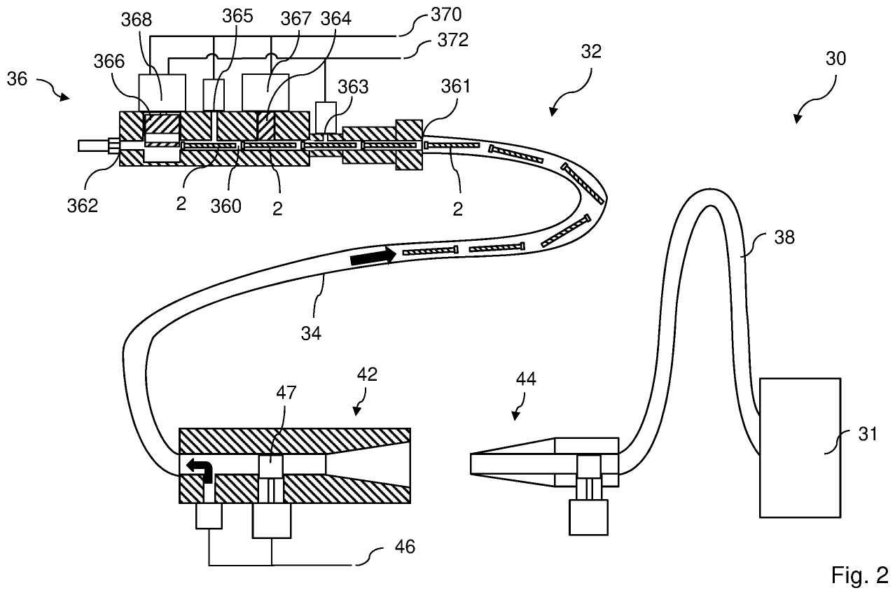

FIGS. 2 to 4 show the element feed system 30 in detail. The stand-by magazine 38 is designed as a feed hose and extends from the sorting device 31 to the second coupling half 44. The magazine device 32 has the first coupling half 42 to which the working magazine 34 in the form of a feed hose is joined. The working magazine 34 ends in the separating device 36. The separating device 36 is designed as a pneumatically actuatable device. It has a duct 360 through which joining elements 2 can be conveyed by means of compressed air. The joining elements 2 pass through the duct 360 in the conveying direction from a feed opening 361 to an outlet opening 362 and thus pass through a first compressed-air feed opening 363, a first duct blocking element 364, a second compressed-air feed opening 365, and a second duct blocking element 366. The spacing between the first and second duct blocking element 364, 366 is chosen such that there is room for no more than one joining element 2 in the duct section situated between the duct blocking elements 364, 366. The first and the second duct blocking element 364, 366 has a first actuating device 367 and a second actuating device 368, respectively, by means of which it can be moved between a blocking position and an pass-through position. The first actuating device 367 is designed, by way of example, with a single-acting pneumatic cylinder. The first duct blocking element 364 can be moved into the blocking position by means of compressed air. When the compressed air is released, the first duct blocking element 364 returns to the pass-through position. The second actuating device 366 is designed by way of example with a double-acting pneumatic cylinder and can be moved into the blocking position or into the pass-through position by means of compressed air. The separating device 36 furthermore has a first compressed-air line 370 via which compressed air can be applied to the first actuating device 367, the second actuating device 368, and the second compressed-air feed opening 365 jointly. The separating device 36 furthermore has a second compressed-air line 372 via which compressed air can be applied to the second actuating device 368 and the first compressed-air feed opening 363 jointly.

The functioning of the joining device 1 is explained in the Figures using the example of a stud welding process and a stud welding device. There could, however, also be other joining elements such as, for example, balls, welding nuts, etc and/or a different joining process with a different joining device, for example a riveting process with an automated riveting device.

FIG. 2 shows the element feed system 30 at the beginning of a joining process sequence in which a plurality of joining elements 2 in the form of welding studs are to be welded to a floor assembly of a vehicle. At least the same number of joining elements 2 are provided in the magazine device 30 as there are welds to be made. Compressed air is introduced into the first coupling half 42 via the compressed-air line 46 such that the joining elements 2 present in the working magazine are pushed in the direction of the separating device 36. The compressed air also closes a slide 47 and blocks a filling opening of the coupling half 42.

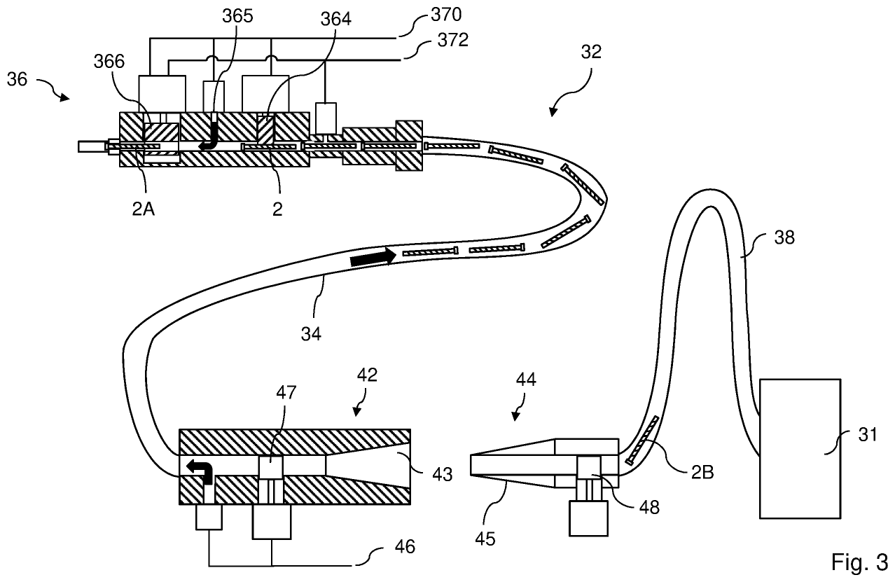

If a first joining element 2A is then to be welded, compressed air is applied to the first compressed-air line 370 of the separating device 36 (see FIG. 3). The first duct blocking element 364 consequently moves into the blocking position and clamps a joining element 2 situated there against the duct wall. The second duct blocking element 366 is moved into the pass-through position by the compressed air. Compressed air is furthermore blown into the duct via the second compressed-air feed opening 365 and pushes the joining element 2A at the front further into the joining head 10.

At the same time, the sorting device 31 is activated such that a joining element 2B is pushed by means of compressed air from the sorting device into the stand-by magazine 38 as far as a position in front of the second coupling half 44. In the second coupling half 44, a slide 48 blocks an outlet opening and retains the element in the stand-by magazine 38.

For actuating the sorting device and actuating the separating device 36, in this method step a first signal from the signal device 50 is used by means of which the joining head 10 is also activated and a loading pin is caused to be drawn back in the stud welding head.

Once the welding has been performed, the signal device 50 controls, with a second signal, the advance of the loading pin in the stud welding head. Compressed air is applied by means of the same second signal to the second compressed-air line 372, as a result of which the second duct blocking element 366 moves into the blocking position and compressed air is blown into the duct 35 via the first compressed-air feed opening 363 (see FIG. 2). The supply of compressed air to the compressed-air line 370 is interrupted, as a result of which the first duct blocking element 364 moves into the pass-through position. As a result, the joining elements 2 situated in the working magazine 34 are advanced as far as the second duct blocking element 366.

This procedure described in FIGS. 2 and 3 is repeated until the joining process sequence is completed and the desired number of welding studs have been set. Each time a joining element 2 is removed from the magazine device 32, a further joining element 2B is supplied in the stand-by magazine 38. At the completion of the joining process sequence, there are the same number of joining elements 2B in the stand-by magazine 38 as there were joining elements 2 removed from the magazine device 32.

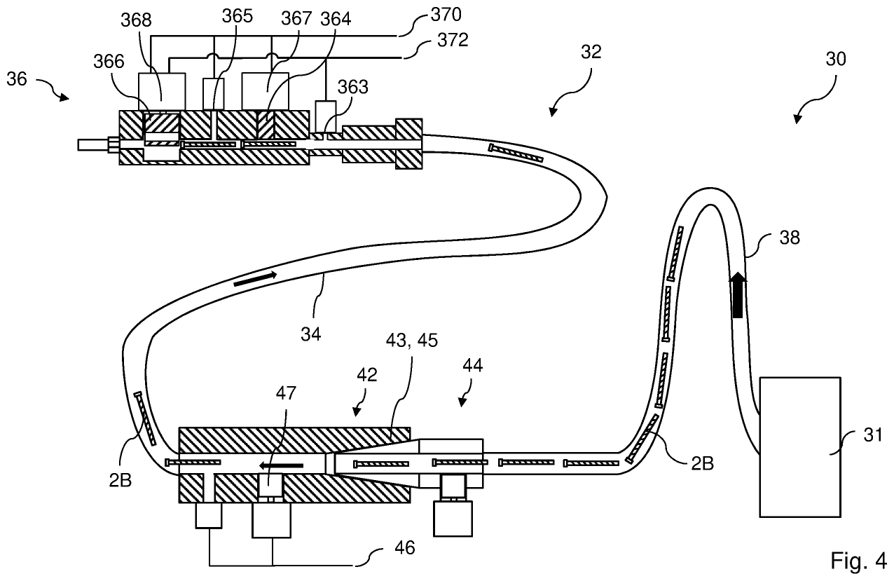

FIG. 4 illustrates the refilling of the magazine device 32. This preferably takes place in a process idle time, for example whilst the floor assembly is being replaced. The robot 20 moves, with the joining head 10 and the magazine device 32, to the stand-by magazine 38 and couples the two coupling halves to each other. A conical coupling piece 45 formed on the second coupling half 44 is here inserted into a corresponding funnel-shaped socket 43 in the first coupling half 42. The slide 48 is opened, the supply of compressed air to the compressed-air line 46 is interrupted, as a result of which the slide 47 is also opened. The joining elements 2B are transported from the stand-by magazine 38 into the magazine device by means of compressed air coming from the sorting device.

A new joining process sequence can then take place, as described with reference to FIGS. 2 and 3.

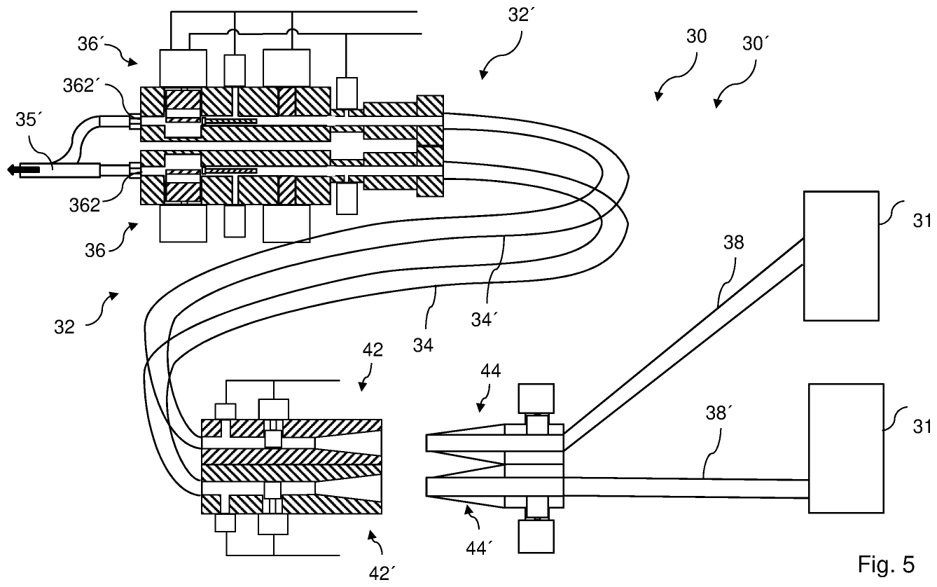

FIG. 5 shows an alternative embodiment which is particularly suitable when two different joining elements 2 and 3 are to be processed in the same joining process sequence. In this embodiment, two element feed systems 30 and 30′ connected in parallel are provided which correspond in their structure and their function in each case to the element feed system 30 described with reference to FIGS. 2 and 3. However, the element feed system 30′ is loaded with joining elements 3 which differ from the joining elements 2 and are, for example, a different type of joining element, for example a welding nut, or have a different size. A feed duct 35′, with a Y-piece, which passes joining elements from the two separating devices 36 and 36′ to the joining head 10, is provided at the outlet openings 362 and 362′ of the separating devices 36 and 36′.

### LIST OF REFERENCE CHARACTERS

1 joining device
2 joining element
10 joining head
20 industrial robot
22 robot console
30, 30′ element feed system
31, 31′ sorting device
32, 32′ magazine device
34, 34′ working magazine
35, 35′ feed duct
36, 36′ separating device
38, 38′ stand-by magazine
40, 40′ coupling device
42, 42′ first coupling half
43 socket
44, 44′ second coupling half
45 conical coupling piece
46 compressed-air line
47, 48 slide
50 control device
360 duct
361 feed opening
362, 362′ outlet opening
363, 365 compressed-air feed openings
364, 366 duct blocking element
367, 368 actuating device
370, 372 compressed-air line

1.-14. (canceled)

15. A joining device, comprising:
a mobile joining head with a joining tool which is arranged on a multi-axis industrial robot;
an element feed system which operates using compressed air; and
a control device which is configured to activate the joining tool and to control the element feed system;
wherein the element feed system has:
a magazine device which is movable together with the joining head and which comprises a working magazine in which a large number of joining elements are accommodatable at a same time and a separating device from which joining elements are conveyable onward individually from the magazine device in a direction of the joining tool;
a stand-by magazine which is stationary and which is fillable with joining elements from a sorting device; and
a coupling device that couples the magazine device to the stand-by magazine, wherein a first coupling half is arranged on the magazine device and a second coupling half is arranged on the stand-by magazine.

16. The joining device according to claim 15, wherein the control device is configured to generate a first signal which causes a joining element to be transported from the magazine device in the direction of the joining tool and causes a joining element to be transported from the sorting device into the stand-by magazine.

17. The joining device according to claim 16, wherein the first signal shifts the joining head into a loading state or wherein the first signal indicates that the joining head is situated in the loading state.

18. The joining device according to claim 15, wherein the stand-by magazine is attached to a console of the industrial robot.

19. The joining device according to claim 15, wherein the stand-by magazine is formed by a feed hose or a compressed-air tube.

20. The joining device according to claim 15, wherein the first coupling half has a funnel-shaped socket and the second coupling half has a corresponding conical coupling piece.

21. The joining device according to claim 15, wherein the first coupling half is arranged at a same height as a last axis of the industrial robot.

22. The joining device according to claim 15, wherein the separating device has:
a duct with a feed opening and an outlet opening through which the joining elements are conveyable;
a first duct blocking element with a first actuating device and a second duct blocking element with a second actuating device, wherein the first duct blocking element and the second duct blocking element are each movable between a blocking position and a pass-through position;
wherein the second duct blocking element is arranged behind the first duct blocking element in a conveying direction of the joining elements;
a first compressed-air feed opening which opens into the duct in front of the first duct blocking element in the conveying direction; and
a second compressed-air feed opening which opens into the duct between the first duct blocking element and the second blocking element in the conveying direction.

23. The joining device according to claim 22, wherein the control device is configured to generate a first signal which causes a joining element to be transported from the magazine device in the direction of the joining tool and causes a joining element to be transported from the sorting device into the stand-by magazine and wherein the separating device has:
a first compressed-air line via which compressed air is applyable to the first actuating device, the second actuating device, and the second compressed-air feed opening jointly;
wherein the first actuating device is configured to move the first duct blocking element into the blocking position;
wherein the second actuating device is configured to move the second duct blocking element into the pass-through position when compressed air is applied to the first compressed-air line;
wherein the first signal from the control device is used to apply compressed air to the first compressed-air line.

24. The joining device according to claim 15, further comprising a second element feed system, wherein the element feed system and the second element feed system are arranged parallel to each other and are routed together to an element holder of the joining head via a feed duct with a Y-piece.

25. The joining device according to claim 15, wherein the joining device is a stud welding device.

26. A method for operating the joining device according to claim 15, comprising the steps of:
joining a large number of joining elements one after the other to a component or an assembly in a joining process sequence, wherein joining elements required for joining are supplied in the magazine device and are transported individually to the joining tool;
during the joining process sequence, filling the stand-by magazine with joining elements by transporting the joining elements individually and in a correct position from the sorting device into the stand-by magazine;
after completing the joining process sequence, moving the industrial robot such that the magazine device is coupled to the stand-by magazine; and
transporting the joining elements from the stand-by magazine into the working magazine by compressed air.

27. The method according to claim 26, wherein the element feed system is controlled such that, each time a joining element is transported from the separating device to the joining tool, a joining element is also transported from the sorting device into the stand-by magazine.

28. The method according to claim 27, wherein transporting of the joining element from the separating device to the joining tool is controlled by a first signal which is furthermore used to shift the joining head into a loading state or which indicates that the joining head is situated in the loading state.
